(19) United States
(12) Patent Application Publication
(10) Pub. No.: US 2014/0092284 A1
(43) Pub. Date: Apr. 3, 2014

(54) LIGHT BLOCKING INK, MICROLENS ARRAY UNIT, AND IMAGE PROCESSING APPARATUS

(71) Applicant: TOSHIBA TEC KABUSHIKI KAISHA, Tokyo (JP)

(72) Inventors: Ryozo AKIYAMA, Shizuoka (JP); Atsushi KUBOTA, Shizuoka (JP)

(73) Assignee: TOSHIBA TEC KABUSHIKI KAISHA, Tokyo (JP)

(21) Appl. No.: 14/040,129

(22) Filed: Sep. 27, 2013

(30) Foreign Application Priority Data
Sep. 28, 2012 (JP) 2012-216427

(51) Int. Cl. C09D 11/00; H04N 5/335; G02B 5/22

(52) U.S. Cl. CPC C09D 11/38; G02B 5/223; H04N 5/335
USPC 348/294; 106/31.78; 359/619

(57) ABSTRACT

A light blocking ink includes a light blocking material, a blue coloring material, and an ultraviolet-curable material. The light blocking ink may be employed in a microlens array unit to block stray light. The microlens array unit includes a substrate, a microlens array, and a light blocking film formed with the light blocking ink. The microlens array unit may be employed in an image processing apparatus.

### CROSS-REFERENCE TO RELATED APPLICATION

This application is based upon and claims the benefit of priority from Japanese Patent Application No. 2012-216427, filed Sep. 28, 2012, the entire contents of which are incorporated herein by reference.

### FIELD

Embodiments described herein relate generally to light blocking ink, particularly light blocking ink used for forming a light blocking film of a lens array unit.

### BACKGROUND

In a lens array unit used in an optical device, a light blocking film is disposed at an area between adjacent lenses to absorb stray light. Such an optical device can be employed in an image processing apparatus such as a printer, a copier, a multifunction printer (MFP), a facsimile, a scanner, a liquid crystal display device, a solid-state imaging device, a multiple image transmission device of an optical interconnection system, and a confocal laser microscope. In addition, a technology of such a lens array unit can be applied to an optical communication field, an optical disc field, an image display field, an image transmission-connection field, an optical measurement field, an optical sensing field, an optical processing field, and the like.

A method for forming such a light blocking film includes a method of printing black ink, which can be cured by ultraviolet rays, on the area between the adjacent lenses and then curing the ink, a method of developing the film and removing a portion of the film by a photolithography, and the like.

### DESCRIPTION OF THE DRAWINGS

FIGS. 1A to 1C illustrate an example of a microlens array according to an embodiment.

FIG. 2 illustrates an example of a light blocking film forming device for manufacturing the microlens array according to the embodiment.

FIG. 3 illustrates an example of an image processing apparatus according to the embodiment.

### DETAILED DESCRIPTION

In forming a light blocking film by applying ink, there is a concern that the applied ink may block the ultraviolet rays, which is used to cure the ink during irradiation of the ultraviolet rays, and the ultraviolet rays may be attenuated in a depth direction of the ink and thus the ink may not be sufficiently cured.

The embodiment provides light blocking ink which decreases attenuation of ultraviolet rays emitted in a depth direction of the ink and which can achieve a sufficient curing property of a light blocking film formed with the ink, and a microlens array unit including such a light blocking film.

In general, according to one embodiment, the light blocking ink includes a light blocking material, a blue coloring material, and an ultraviolet-curable material.

Hereinafter, the embodiment will be described in detail with reference to the drawings. When the same reference numerals are used in the following descriptions, the same reference numerals mean to have the same configuration and function.

### Microlens Array

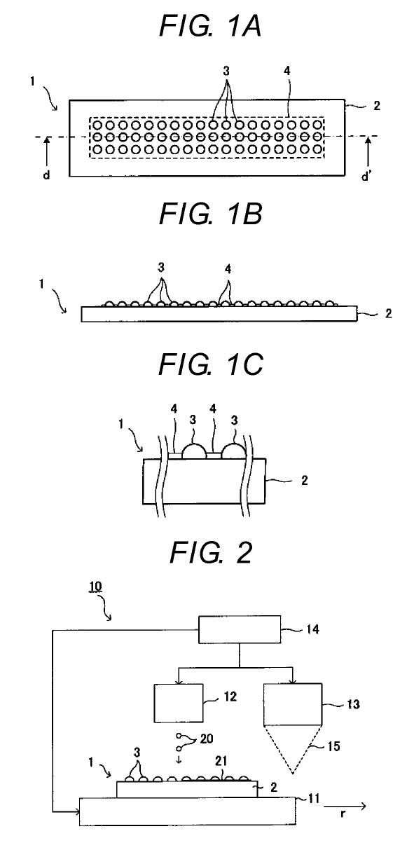

A configuration of a microlens array according to an embodiment will be described in detail with reference to FIGS. 1A to 1C. FIGS. 1A to 1C illustrate a microlens array 1 according to the embodiment. FIG. 1A is a top view of the microlens array 1, FIG. 1B is a cross-sectional view taken along dashed line d-d′ of FIG. 1A, and FIG. 1C is an enlarged view of FIG. 1B.

As shown in FIGS. 1A to 1C, the microlens array 1 includes a plurality of lenses 3 on a transparent substrate 2. The microlens array 1 includes light blocking film 4 of a black color and having a depth (film thickness) of 12 μm, for example, which is formed between the adjacent lenses 3. “Between the adjacent lenses 3” means that the light blocking film 4 is formed at non-lens portions. The light blocking film 4 is formed of light blocking ink according to the embodiment. The substrate 2 and the lenses 3 are formed with metallic molding, for example. In FIGS. 1A to 1C, a case in which the lenses 3 are disposed on one surface of the substrate 2 is illustrated, however, the lenses 3 can be formed on both surfaces of the substrate 2. The microlens array 1 and the light blocking films 4 are collectively referred to as a microlens array unit, in some cases.

A light blocking film forming device including an ink jet head is used for forming the light blocking film 4, for example. FIG. 2 shows a schematic configuration of a light blocking film forming device 10.

As shown in FIG. 2, the light blocking film forming device includes a transportation table 11 transporting the microlens array 1, an ink jet printing unit 12 ejecting light blocking ink 20, an ultraviolet ray irradiation unit 13, and a control unit 14 which controls the above units.

The transportation table 11 holds the microlens array 1 formed on the transparent substrate 2 including the plurality of lenses 3, moves in an arrow “r” direction, and transports the microlens array 1 to a position of the ink jet printing unit 12 and to a position of the ultraviolet ray irradiation unit 13. The ink jet printing unit 12 ejects the light blocking ink 20 an area of the substrate 2 between the adjacent lenses 3 from the top of the substrate 2. The ultraviolet ray irradiation unit 13 irradiates light blocking ink 21 ejected to the substrate 2 with ultraviolet rays 15, from the top of the substrate 2. In a case of the microlens array in which the lenses 3 are disposed on both surfaces of the substrate 2, after forming the light blocking films on one surface (front surface), the substrate 2 is turned around and set on the transportation table 11, and by performing the same operation, the light blocking film can be formed on the other surface (rear surface) of the substrate 2.

The control unit 14 controls transportation speed and transportation timing of the transportation table 11. In addition, the control unit 14 controls an amount of the light blocking ink 20 ejected from the ink jet printing unit 12. The ejected amount of the light blocking ink 20 is controlled by adjusting voltage applied to the ink jet printing unit 12 for ejecting the ink, for example. As another controlling method, with a multi-drop printing for dropping a plurality of minute light blocking ink droplets ejected from the ink jet printing unit 12 to the same position, the ejected amount of the light blocking ink can be controlled by adjusting the number of the liquid droplets. Further, the control unit 14 controls irradiance of the ultraviolet rays, a wavelength of the ultraviolet rays, and the like of the ultraviolet ray irradiation unit 13.

By replacing the ink jet printing unit 12 with an ink applying device, the light blocking film forming device 10 can supply the light blocking ink not by the ink jet method, but by an application method. The transportation table 11 may be fixed and the inkjet printing unit 12 and the ultraviolet ray irradiation unit 13 may scan the substrate 2 by moving along the microlens array, and a plurality of ink jet printing units 12 and ultraviolet ray irradiation units 13 may be provided. For efficient curing of the light blocking ink 21, the ultraviolet ray irradiation can be also performed from the rear surface of the substrate 2, by forming a portion of the transportation table 11 for attaching the transparent substrate 1 with a glass plate, for example.

In a case of using a cationic photo-curable material which will be described later, efficient curing can be performed by a heating the light blocking ink after the ultraviolet ray irradiation. The cations generated by the heating after the irradiation diffuse, and reactive polymerizable compounds such as monomers or oligomers can be effectively cured due to polymerization. The heating temperature or the heating time can be suitably set within a range of not affecting the lens shape of the microlens array or optical properties of the lens.

### Light Blocking Ink

The light blocking ink 20 used for forming the light blocking film 4 is mainly formed of a light blocking material, a blue coloring material, and photo-curable materials.

### Light Blocking Material

For the light blocking materials, an optical light blocking property and a reflective property are primarily required. In addition, in a case of using the ink jet printing method, a flying property, dispersion stability, and the like as the ink properties are further required. In consideration of these properties, pigments having a light absorbing property are used for the light blocking materials.

Examples of such light blocking materials include carbon-based pigments such as carbon black and carbon nanotubes, metal oxide pigments such as iron black, zinc oxide, titanium oxide, chromium oxide, and iron oxide, sulfide pigments such as zinc sulfide, phthalocyanine-based pigments, pigments formed of salts such as sulfates, carbonates, silicates, and phosphates of metals, and pigments formed of metal powder such as aluminum powder, bronze powder, and zinc powder. One of these pigments can be used alone or two or more pigments can be used in combination.

### Blue Coloring Material

As the blue coloring material, a cyan pigment which performs light absorption in a wavelength range in the vicinity of 600 nm is used. Examples of the blue coloring material include C.I. Pigment Blue 15:3, C.I. Pigment Blue 15:34, C.I. Pigment Blue 16, C.I. Pigment Blue 22, C.I. Pigment Blue 60, C.I. Pigment Blue 1, C.I. Pigment Blue 2, C.I. Pigment Blue 3, C.I. Vat Blue 4, and C.I. Vat Blue 60.

The particle size of the light blocking material and the blue coloring material is not particularly limited, as long as a film of a desired thickness can be formed, and the particle size thereof can be suitably selected according to the printing method. For example, in a case of using the ink jet printing method, the particle size thereof is preferably equal to or less than 300 nm, from a viewpoint of clogging of the ink or an ejecting property such as a flying property.

A ratio of the light blocking material with respect to the entire light blocking ink is preferably in a range of 5 wt % to 15 wt %, and a ratio of the blue coloring material with respect to the entire light blocking ink is preferably in a range of 2 wt % to 6 wt %. In a case where the ratio of the light blocking material is less than 5 wt %, the sufficient light blocking performance is not obtained without forming a significantly thick film, and the effect of the blue coloring material is marginal. On the other hand, in a case where the ratio of the light blocking material is more than 15%, the effect of the blue coloring material may be difficult to be achieved. For example, when the film thickness is set to be about a few μm, the effect of the blue coloring material is achieved to some extent. However, when the film thickness is equal to or more than 10 μm, the effect thereof almost cannot be achieved.

### Photo-Curable Materials

The photo-curable materials used for the light blocking ink of the embodiment are main component of the light blocking film, and are formed of reactive polymerizable compounds which are polymerized with light, such as reactive monomers and oligomers having a polymerizable functional group, and a photoinitiator which starts this polymerization.

Currently, various reactive polymerizable compounds are used for various purposes, and based on pattern of the polymerization, the reactive polymerizable compounds can be divided into a radical type and a cationic type. As the radical-type reactive polymerizable compounds, an acrylic monomer/oligomer having an acryloyl functional group is representative, and the polymerization is facilitated by radicals generated from the photoinitiator irradiated with light. At the time of the radical type polymerization, the occurrence of oxygen inhibition and relatively large volume contraction after the curing are disadvantages.

Meanwhile, examples of the cationic-type reactive polymerizable compounds include a cyclic ether compound represented by an epoxy or oxetane compound, and a vinyl ether compound having a vinyl ether group, and a photoacid generating agent, which starts polymerization using protons generated by light irradiation, is used as a photoinitiator. Among them, the cyclic ether compound has small volume contraction after polymerization, and accordingly has an excellent adhesiveness with a base material. The cationic polymerization is different from the radical type polymerization in points of performing polymerization without oxygen inhibition and having an excellent property for forming a thin film.

For the light blocking film for the microlens array unit, materials which satisfy both the above-described properties and the ink properties suitable for the ink jet method can be selected. That is, the material used for the light blocking ink of the embodiment is not particularly limited, as long as the material satisfies properties such as the light blocking property, the reflective property, cured film strength, and ultraviolet ray curing conditions, physical properties such as viscosity and surface tension as the ultraviolet curable ink property with the ink jet method, light blocking dispersion stability, compatibility with a head member, and the like.

As the radical reactive polymerizable compound, depending on the number of acryloyl groups in a molecule, monomers such as monofunctional acrylate, bifunctional acrylate, or trifunctional and more acrylate, or oligomers such as polyester acrylate, urethane acrylate, and epoxy acrylate are used. Among them, the monofunctional monomer is used as a reactive diluent, and also in many cases plays an important role as a material for adjusting viscosity in the ink jet ink.

Examples thereof include an acrylic acid adduct of isobornyl acrylate, acryloylmorpholine, dicyclopentadienyl acrylate, and phenyl glycidyl ether, 2-hydroxyethyl acrylate, 2-hydroxypropyl acrylate, 2-hydroxybutyl acrylate, 2-hydroxyhexyl acrylate, ethyl carbitol acrylate, tetrahydrofurfuryl acrylate, 2-acryloyloxyethyl phthalate, benzyl acrylate, and methacryl acrylates such as 2-hydroxyhexyl methacrylate, allyl methacrylate, benzyl methacrylate, and cyclohexyl methacrylate. In addition, other than acrylate-based compounds, N-vinylpyrrolidone, N-vinyl caprolactam, and the like are also useful as a diluent. Examples of the bifunctional acrylate include neopentyl glycol diacrylate, nonanediol diacrylate, tripropylene glycol diacrylate, tricyclodecanedimethanol diacrylate, and bisphenol A EO adduct acrylate, and examples of the polyfunctional acrylate include trimethylolpropane triacrylate, pentaerythritol triacrylate, dipentaerythritol pentaacrylate, isocyanurate EO adduct triacrylate, and the like.

Examples of the cationic reactive polymerizable compound include an alicyclic epoxy compound, an oxetane compound, a vinyl ether compound, and the like.

As the alicyclic epoxy compound, a hydrocarbon group having a divalent aliphatic skeleton or alicyclic skeleton, or a compound having an epoxy group or an alicyclic epoxy group in one or both divalent groups partially having an aliphatic chain or an alicyclic skeleton can be used. Examples thereof include alicyclic epoxy compounds such as CELLOXIDE 2021, CELLOXIDE 2021A, CELLOXIDE 2021P, CELLOXIDE 2081, CELLOXIDE 2000, and CELLOXIDE 3000 manufactured by Daicel Corporation, CYCLOMER A200, CYCLOMER M100, and methyl glycidyl methacrylate (MGMA) which are (meth)acrylate compounds having an epoxy group, a low-molecular epoxy compound such as glycidol, β-methyl epichlorohydrin, α-pinene oxide, C12 to C14 α-olefin monoepoxide, and C16 to C18 α-olefin monoepoxide, epoxidized soybean oil such as Daimac S-300K, epoxidized linseed oil such as Daimac L-500, and multifunctional epoxy such as Epolead GT301 and Epolead GT401. In addition, alicyclic epoxy compounds such as CYRACURE manufactured by Dow Chemical Company, a compound in which a terminal hydroxyl group of a hydrogenated aliphatic low-molecular phenol compound is substituted with a group having an epoxy, a glycidyl ether compound such as polyvalent aliphatic alcohols/alicyclic alcohols such as ethylene glycol, glycerin, neopentyl alcohol, hexanediol, and trimethylolpropane, and glycidyl ester of hexahydrophthalic acid or hydrogenated aromatic polyvalent carboxylic acids can be used. These alicyclic epoxy compounds may be used alone or in combination of two or more kinds.

Examples of the oxetane compound include compounds in which one or more oxetane-containing groups are introduced to alicyclic compounds such as di[1-ethyl(3-oxetanyl)]methyl ether, 3-ethyl-3-(2-ethylhexyloxymethyl)oxetane, [(1-ethyl-3-oxetanyl)methoxy]cyclohexane, bis[(1-ethyl-3-oxetanyl)methoxy]cyclohexane, and bis[(1-ethyl-3-oxetanyl)methoxy]norbornane, and ether compounds in which the oxetane-containing alcohol such as 3-ethyl-3-hydroxymethyloxetane is subject to dehydration synthesis to aliphatic polyvalent alcohols such as ethylene glycol, propylene glycol, and neopentyl alcohol. Examples of the oxetane compound containing an aromatic skeleton include 1,4-bis((1-ethyl-3 oxetanyl)methoxy)benzene, 1,3-bis((1-ethyl-3 oxetanyl)methoxy)benzene, 4,4′-bis((3-ethyl-3 oxetanyl)methoxy)biphenyl, and phenol novolac oxetanes. The oxetane compound may be used alone, or two or more kinds of oxetane compounds may be used in combination.

Examples of vinyl ether compounds include 2-ethylhexyl vinyl ether, butanediol divinyl ether, cyclohexanedimethanol divinyl ether, cyclohexanedimethanol monovinyl ether, diethylene glycol monovinyl ether, diethylene glycol divinyl ether, hexanediol divinyl ether, triethylene glycol divinyl ether, 4-hydroxybutyl vinyl ether, and the like. The vinyl ether compound may be used alone, or two or more kinds of vinyl ether compounds may be used in combination.

A ratio of the reactive polymerizable compound with respect to the entire ink is preferably 67% by weight to 82% by weight. When the ratio thereof is less than 67% by weight, the light blocking material becomes relatively abundant in the ink, and the curing effect may be insufficient with a light irradiation for a short time. On the other hand, when the ratio thereof exceeds 82% by weight, in a case of forming a thin light blocking film, the sufficient light blocking property may not be achieved.

In a case where decrease of the viscosity and further improvement of the curing speed are required, the vinyl ether compound expressed by the following Formula (1) is preferably used alone or in combination with the other vinyl ether compound in the ink, as the reactive polymerizable compound. Among the vinyl ether compounds, since polymerization inhibition due to the pigment is significant, attention is required when using the methylene-group-bonded vinyl ether compound such as aliphatic glycol derivatives or cyclohexane dimethanol. However, when using the compound having a vinyl ether group directly on an alicyclic skeleton, a terpenoid skeleton, or an aromatic skeleton, which is expressed by the following Formula (1), the polymerization inhibition due to the pigment hardly occurs and the curing performance is excellent compared to that of the vinyl ether compound described above.

[Chem. 1]

R¹-R²R¹)ₚ (1)

In Formula (1), at least one of R¹ is a vinyl ether group, and R¹ represents a group selected from a vinyl ether group and a hydroxyl group. R² is a (p+1)-valent group selected from an alicyclic skeleton or a skeleton including an aromatic ring, and p is a positive integer or 0. However, when R² is a cyclohexane ring skeleton and p is 0, at least one carbon on the ring has a ketone structure.

Examples of the (p+1)-valent organic group include a (p+1)-valent group including a benzene ring, a naphthalene ring, or a biphenyl ring, and a (p+1)-valent group derived from a cycloalkane skeleton, a norbornane skeleton, an adamantane skeleton, a tricyclodecane skeleton, a tetracyclododecane skeleton, a terpenoid skeleton, a cholesterol skeleton, or the like.

Examples thereof include an alicyclic polyol such as cyclohexane (poly)ol, norbornane (poly)ol, tricyclodecane (poly)ol, adamantane (poly)ol, benzene (poly)ol, naphthalene (poly)ol, anthracene (poly)ol, or biphenyl (poly)ol, a compound in which a hydrogen atom of a hydroxyl group of a phenol derivative is substituted with a vinyl group, and the like. Compounds such as polyvinyl phenol and phenol novolac in which a hydrogen atom of a hydroxyl group of a polyphenol compound is replaced by a vinyl group are used. These compounds are desirable since the volatility is decreased, even when a part of the hydroxyl group remains or methylene atoms of a part of the alicyclic skeleton are replaced by a ketone group or the like. Particularly, since the cyclohexyl monovinyl ether compound has excellent volatility, when using the cyclohexyl monovinyl ether compound, the cyclohexane ring is desirably oxidized at least to a cyclohexanone ring.

The combination amount of the compound expressed by Formula (1) is preferably a ratio of equal to or less than 50% by weight with respect to the entire liquid ink for maintaining thermoplasticity. In a case where the higher solvent resistance and hardness are required even with the damage to the thermoplasticity of the light blocking film, the added material thereof may be increased up to the same amount as the total amount of the reactive polymerizable compound combined in the ink.

The photopolymerization initiator may be of a radical type or cationic type, and can be suitably selected depending on the reactive polymerizable compound to be combined. As the radical-type photopolymerization initiator, benzoin ether-based, acetophenone-based, or phosphine oxide-based material is used, for example, and a cleavage type such as 1-hydroxycyclohexyl phenyl ketone, diethoxyacetophenone, 2-hydroxy-2-methyl-1-phenyl-propan-1-one, and 2-benzyl-2-dimethylamino-1-(4-morpholinophenyl)-butanone-1, and a hydrogen abstraction type such as benzophenone, 2,4-diethylthioxanthone, and isopropylthioxanthone are used.

As the cationic photopolymerization initiator, onium salts, diazonium salts, quinone diazide compounds, organic halides, aromatic sulfonate compounds, bisulfone compounds, sulfonyl compounds, sulfonate compounds, sulfonium compounds, sulfamide compounds, iodonium compounds, sulfonyl diazomethane compounds, and a mixture thereof can be used, for example. Examples thereof include triphenyl sulfonium triflate, diphenyl iodonium triflate, 2,3,4,4-tetrahydroxybenzophenone-4-naphthoquinone diazide sulfonate, 4-N-phenyl-amino-2-methoxyphenyl diazonium sulfate, 4-N-phenyl-amino-2-methoxyphenyl diazonium p-ethyl phenyl sulfate, 4-N-phenyl-amino-2-methoxyphenyl diazonium 2-naphthyl sulfate, 4-N-phenyl-amino-2-methoxyphenyl diazonium phenyl sulfate, 2,5-diethoxy-4-N-4′-methoxyphenyl carbonyl phenyl diazonium-3-carboxy-4-hydroxyphenyl sulfate, 2-methoxy-4-N-phenyl phenyl diazonium-3-carboxy-4-hydroxyphenyl sulfate, diphenyl sulfonyl methane, diphenyl sulfonyl diazomethane, diphenyl disulfone, α-methyl benzoin tosylate, pyrogallol trimesylate, benzoin tosylate, and the like.

As the photosensitizer, an anthracene diether compound expressed by the following Formula (2) is used, for example.

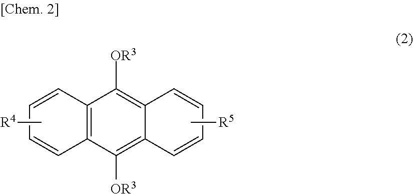

(Wherein, R³ represents a monovalent organic group having 1 to 5 carbon atoms, and R⁴ and R⁵ each independently represent a hydrogen atom, an alkyl group having 1 to 3 carbon atoms, an alkylsulfonyl group or an alkoxy group.)

In Formula (2), examples of the monovalent organic group which is represented as R³ include an alkyl group, an aryl group, a hydroxyalkyl group, an alkoxyalkyl group, an allyl group, a benzyl group, and a vinyl group.

Examples of the alkyl group include a methyl group, an ethyl group, an n-propyl group, an i-propyl group, an n-butyl group, an i-butyl group, a t-butyl group, an n-pentyl group, and an i-pentyl group. Examples of the aryl group include a phenyl group, a biphenyl group, an o-tolyl group, an m-tolyl group, and a p-tolyl group. Examples of the hydroxyalkyl group include a 2-hydroxyethyl group, a 3-hydroxypropyl group, a 2-methyl-2-hydroxyethyl group, and a 2-ethyl-2-hydroxyethyl group. In addition, examples of the alkoxyalkyl group include a 2-methoxyethyl group, a 3-methoxypropyl group, a 2-ethoxyethyl group, and a 3-ethoxypropyl group. In addition, examples of the allyl group include a 2-methylallyl group and the like. The compounds having such groups can be synthesized by a method disclosed in J. Am. Chem. Soc., Vol. 124, No. 8, 1590 (2002), for example.

R⁴ and R⁵ are not particularly limited as long as they are represented in Formula, and both of them are preferably hydrogen atoms in terms of simple synthesis.

Examples of the compound represented by Formula (2) include a dialkoxyanthracene such as 9,10-dimethoxyanthracene, 9,10-diethoxyanthracene, 9,10-dipropoxyanthracene, 9,10-dibutoxyanthracene, 2-ethyl-9,10-diethoxyanthracene, and 2,3-diethyl-9,10-diethoxyanthracene, 9,10-diphenoxyanthracene, 9,10-diallyloxyanthracene, 9,10-di(2-methylallyloxy)anthracene, 9,10-divinyloxyanthracene, 9,10-di(2-hydroxyethoxy)anthracene, 9,10-di(2-methoxyethoxy)anthracene, and the like. Any of these compounds can be used to exhibit sufficient effects, however, 9,10-dibutoxyanthracene and 9,10-divinyloxyanthracene are particularly preferable, in terms of purchase cost of the compound or the synthetic raw materials thereof, and safety of the compound.

A ratio of the photosensitizer with respect to the photoacid generating agent depends on the kind of the compound to be used. However, in general, if the photosensitizer is combined at a ratio of about 10% by weight to 50% by weight with respect to the photoacid generating agent, the effect thereof can be achieved.

In addition, a polymerization inhibitor can be included in the light blocking ink of the embodiment, if necessary. The polymerization inhibitor may be of cationic type or radical type. In a case of the cationic type, n-hexylamine, dodecylamine, aniline, dimethylaniline, diphenylamine, triphenylamine, diazabicyclooctane, diazabicycloundecane, 3-phenylpyridine, 4-phenylpyridine, lutidine, 2,6-di-t-butylpyridine, and the like can be used. In a case of the radical type, DPPH (1,1-diphenyl-2-picrylhydrazyl), TEMPO (2,2,6,6-tetramethyl piperidinyl-1-oxyl), p-benzoquinone, chloranil, nitrobenzene, hydroquinone (HQ), methyl hydroquinone (MEHQ), t-butyl catechol, dimethylaniline, and the like are used.

In order to produce an ultraviolet-curable light blocking ink including these materials, after performing a dispersion step of dispersing the light blocking material in monomer, and a mixing step of mixing and stirring while adding suitable reactive polymerizable compounds such as a monomer and oligomer and photoacid generating agent, and if necessary, additives such as the sensitizer and the polymerization inhibitor, to the obtained dispersion liquid, a purification step of performing filtering or centrifugal separation for removing coarse particles or unnecessary solid content is performed. In the dispersion step, a dispersant can be added, if necessary, for improving the dispersion properties of the blocking materials. Examples of the dispersant include nonionic and ionic surfactants, and a polymer dispersant.

In a case of producing the light blocking ink to be used in the ink jet printing method, it is desirable to set the viscosity of the ink in a range of 5 mPa·s to 30 mPa·s at 25° C., and the surface tension thereof in a range of 22 mN/m to 40 mN/m. The viscosity value or the surface tension of the light blocking ink can be set by a ratio of the reactive polymerizable compounds or the like with respect to the ink.

### Image Processing Apparatus

The microlens array unit according to the embodiment is used in an image processing apparatus as described below.

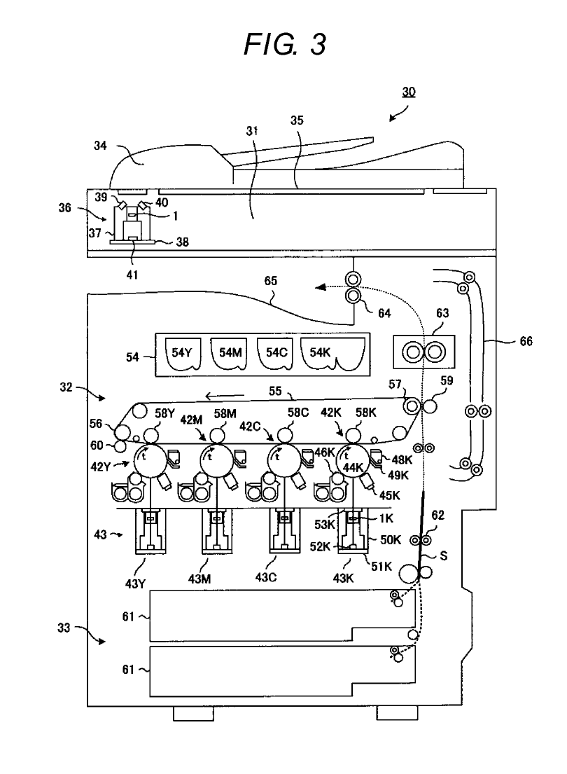

FIG. 3 shows a schematic configuration of an image forming apparatus 30 according to the embodiment. As shown in FIG. 3, the image forming apparatus 30 includes a scanner unit 31 which reads an image of a document or the like, a printer unit 32 which processes image data or the like generated in the scanner unit 31 to form an image on paper, and a paper feeding unit 33 which feeds paper to the printer unit 32.

The scanner unit 31 is provided on an upper portion of the image forming apparatus 30, is a unit which reads a document sent by an automatic document transportation device 34 or a document placed on a document table 35 and generates image data, and includes an image sensor 36.

The image sensor 36 is a one-dimensional sensor disposed in a main scanning direction (depth direction in FIG. 3), and includes a case 37. The case 37 is disposed on a substrate 38, and light sources (light emitting elements) 39 and 40 which emit light to a direction of a document are provided so as to be extended in the main scanning direction on the upper surface of the case 37 on the document table 35 side. As the light sources 39 and 40, an LED, a fluorescent tube, a xenon tube, a cold-cathode tube, an organic EL or the like can be used. The microlens array 1 is supported between the light sources 39 and 40 on the upper portion of the case 37, and a sensor 41, such as a CCD, CMOs or the like, is mounted on the substrate 38 which is on the bottom portion of the case 37.

The light sources 39 and 40 irradiate an image reading position of a document placed on the document table 35, and light reflected from the image reading position enters the microlens array 1. The microlens array 1 functions as an erecting equal-magnification lens, and the light incident to the microlens array 1 exits from an exit surface of the microlens array 1, and is focused on the sensor 41. The focused light is converted into an electric signal by the sensor 41, and the electric signal is transmitted to a memory unit (not shown) of the substrate 38.

The printer unit 32 is provided on a center portion of the image forming apparatus 30, and includes image forming units 42Y, 42M, 42C, and 42K which performs image forming of yellow (Y), magenta (M), cyan (C), and black (K) respectively, and an exposure device 43 including scanning heads 43Y, 43M, 43C, and 43K corresponding to the image forming units. The image forming units 42Y, 42M, 42C, and 42K are disposed on a lower side of an intermediate transfer belt 55 in parallel from upstream to downstream in a direction in which the intermediate transfer belt 55 moves.

Hereinafter, the image forming unit 42K will be described as an example, since the image forming units 42Y, 42M, 42C, and 42K have the same configuration. In the same manner, the scanning head 43K will be described as an example, since the scanning heads 43Y, 43M, 43C, and 43K have the same configuration.

The image forming unit 42K includes a photoconductor drum 44K, which is an image holding body. In a vicinity of the photoconductor drum 44K, a charger 45K, a developing unit 46K, a primary transfer roller 58K, a cleaner 48K, and a blade 49K, and the like are disposed along a rotation direction “t.” An exposure position of the photoconductor drum 44K is irradiated with light from the scanning head 43K, and an electrostatic latent image is formed on the photoconductor drum 44K.

The charger 45K evenly charges the entire surface of the photoconductor drum 44K. The developing unit 46K supplies a two-component developer containing a black toner and a carrier to the photoconductor drum 44K by a developing roller to which a developing bias is applied. The cleaner 48K removes toner remaining on the surface of the photoconductor drum 44K using the blade 49K.

The scanning head 43K includes a microlens array unit 1K, and the microlens array unit 1K is supported by a holding member 50K. In addition, a supporter 51K is provided on a bottom portion of the holding member 50K, and a light emitting elements 52K such as LED is disposed on the supporter 51K. The light emitting elements 52K are provided linearly in the main scanning direction with even intervals. In addition, a substrate (not shown) containing a driver IC which controls light emission of the light emitting element 52K is disposed on the supporter 51K. The driver IC forms a control unit, generates a control signal to control the scanning head 43K based on the image data, and allows the light emitting element 52K to emit light with a predetermined light intensity according to the control signal. The light rays exiting from the light emitting element 52K enter the lens array 1, pass through the lens array 1 to be focused on the photoconductor drum 44K, and an image is formed on the photoconductor drum 44K. In addition, a cover glass 53K is attached to an upper portion (exit side) of the scanning head 43K.

A toner cartridge 54 which supplies toner to the developing units 46Y, 46M, 46C, and 46K, is provided on an upper portion of the image forming units 42Y, 42M, 42C, and 42K. The toner cartridge 54 includes toner cartridges 54Y, 54M, 54C, and 54K of respective colors which are yellow (Y), magenta (M), cyan (C), and black (K).

The intermediate transfer belt 55 moves cyclically. The intermediate transfer belt 55 is extended by a driving roller 57 and a driven roller 56. In addition, the intermediate transfer belt 55 opposes and is in contact with the photoconductor drums 44Y, 44M, 44C, and 44K. Primary transfer voltage is applied to a position of the intermediate transfer belt 55 opposing the photoconductor drum 44K, by the primary transfer roller 58K, and the toner image on the photoconductor drum 44K is primarily transferred to the intermediate transfer belt 55.

A secondary transfer roller 59 is disposed to oppose the driving roller 57 suspending the intermediate transfer belt 55. When a sheet S passes between the driving roller 57 and the secondary transfer roller 59, secondary transfer voltage is applied to the sheet S by the secondary transfer roller 59. Then, a toner image on the intermediate transfer belt 55 is secondarily transferred to the sheet S. A belt cleaner 60 is provided in the vicinity of the intermediate transfer belt 55.

The paper feeding unit 33 includes a plurality of paper feeding cassettes 61 which accommodate sheets of various sizes. A transporting roller 62 which transports the sheet S taken out from the inside of the paper feeding cassette 61 is provided between the paper feeding cassette 61 and the secondary transfer roller 59. A fixing device 63 is provided downstream with respect to the secondary transfer roller 59. A transporting roller 64 is provided downstream with respect to the fixing device 63. The transporting roller 64 discharges the sheet S to a paper discharging tray 65. Further, a reverse transporting path 66 is formed downstream with respect to the fixing device 63. The reverse transporting path 66 reverses the sheet S to introduce the sheet in a direction of the secondary transfer roller 59, and is used when performing double-sided printing.

### Application by Dispenser

As a method of applying the light blocking ink and the lens unit materials to form the microlens array according to the embodiment, application of a very small amount of liquid by a dispenser can be performed. For example, it can be performed by a non-contact type jet dispenser (CyberJet 2) manufactured by Musashi Engineering, Inc., a micro dispenser (Heishin Micro Dispenser) manufactured by HEISHIN Ltd., or a micro dispenser (Nanojet) manufactured by Microdrop Technologies. A predetermined amount of the light blocking ink or lens unit material liquid is applied on the lens base material using the above dispensers, curing is performed immediately after the application, and the application and curing are repeated, to form a lens configuration.

### EXAMPLES

Hereinafter, the embodiment will be described in more detail with practical examples.

### Preparation of Light Blocking Dispersion Liquid

The light blocking material, the dispersant, and the reactive polymerizable compound as a solvent shown below were mixed, and mixed liquids having different combination ratios of the light blocking material were obtained. As the light blocking material, a carbon black pigment and Pigment Blue 15:3 as a cyan pigment were used.

| | |
|---|---|
| Light blocking material | 20% by weight |
| (Carbon black pigment) | |
| (Blue coloring material; Pigment Blue 15:3) | |
| Dispersant (Avecia Solsperse 32000) | 5.5% by weight |
| Dispersant (Avecia Solsperse 22000) | 0.7% by weight |
| Reactive polymerizable compound (Oxetane 221) | 73.8% by weight |

A dispersion treatment was performed on the obtained mixture for about 1 hour using a circulating sand mill filled with beads having a diameter of 0.5 mm. After the dispersion treatment, the coarse particles were removed using a filter having a pore diameter of 5 μm, and light blocking dispersion liquids having different combination ratios of the carbon black pigment and the cyan pigment were obtained. In the embodiment, since the ink jet ink is used, the treatment with the filter was performed to obtain a small average particle size and sharp particle size distribution, however, the treatment described above may be omitted in a case of not using the ink jet ink.

### Preparation of Light Blocking Ink

The reactive polymerizable compound, the photoacid generating agent, and the sensitizer were combined with the prepared light blocking dispersion liquid, and were mixed and stirred for about 1 hour using a stirrer such as a homogenizer. The obtained mixed liquids were filtered with a 5 μm membrane filter, to obtain ink Nos. 1 to 6 having the ratio of the light blocking material and the blue coloring material different from each other. In addition, in a case of manufacturing a lens by a method other than ink application by the ink jet method, the filtering step can be omitted. Table 1 shows combination ratios of each ink. Table 1 shows the combination ratios including the light blocking dispersion liquid, and the ratio of the dispersant is contained in OXT 221 (that of the reactive polymerizable compound).

TABLE 1

| | Light blocking | | Reactive polymerizable | | | Photoacid | |
|---|---|---|---|---|---|---|---|
| | material | | compound | | | generating agent | |
| | Carbon black | Cyan | | | OXT | ESACURE | Sensitizer |
| | pigment | pigment*¹ | C3000*² | DEGDVE*³ | 221*⁴ | 1064*⁵ | DBA*⁶ |
| No. 1 | 10 | 0 | 14 | 14 | 51 | 10 | 1 |
| No. 2 | 9 | 1 | 14 | 14 | 51 | 10 | 1 |
| No. 3 | 8 | 2 | 14 | 14 | 51 | 10 | 1 |
| No. 4 | 7 | 3 | 14 | 14 | 51 | 10 | 1 |
| No. 5 | 6 | 4 | 14 | 14 | 51 | 10 | 1 |
| No. 6 | 5 | 5 | 14 | 14 | 51 | 10 | 1 |

Note
*¹C.I. Pigment Blue 15:3 (phthalocyanine pigment)
*²limonene dioxide (alicyclic epoxy monomer; manufactured by Daicel Corporation)
*³diethylene glycol divinyl ether (aliphatic vinyl ether monomer; manufactured by Sigma-Aldrich Co. LLC.)
*⁴di(1-ethyl(3-oxetanyl)methyl ether (oxetane monomer; manufactured by TOAGOSEI CO., LTD.)
*⁵sulfonium salt-based photoacid generating agent (manufactured by Lamberti Chemicals)
*⁶9,10-dibutoxyanthracene (manufactured by KAWASAKI KASEI CHEMICALS)

### Evaluation of Ink

The following evaluation of the obtained ink Nos. 1 to 6 was performed.

### Discharging Property of Ink Jet

When the discharging performance of the ink Nos. 1 to 6 was examined using CB1 Head manufactured by TOSHIBA TEC CORPORATION, discharging failure such as leakage or misdirection did not occur in any ink.

### Curing Property

The obtained ink Nos. 1 to 6 were applied on the glass plate using a spin coater so that formed films have a thickness of 10 μm, 12 μm, 15 μm, and 18 μm, respectively, and UV light irradiation was performed with respect to this film under the irradiation conditions of an irradiation intensity of 1000 mW/cm² (365 nm) and a cumulated light amount of 1000 mJ/cm² using a UV light irradiation apparatus. The curing degree of the film after the UV light irradiation was determined by examining solidity thereof with a finger touch.

The determination criteria are as follows. The evaluation results are shown in Table 2.
A: No mark observed when touched with a finger.
B: Mark observed when touched with a finger.
C: Not cured or peeled off.

TABLE 2

Film thickness (μm)

| | 10 | 12 | 15 | 18 |
|---|---|---|---|---|
| No. 1 | B | B | C | C |
| No. 2 | A | B | B | C |
| No. 3 | A | A | B | B |
| No. 4 | A | A | A | B |
| No. 5 | A | A | A | B |
| No. 6 | A | A | A | A |

### Transmission Density (OD)

Transmission density (OD) of the coating film cured in the evaluation of the curing property was measured using a measuring device 361T (measurement limit; OD=6.0) manufactured by X-Rite, Inc. The measured results are shown in Table 3.

The transmission density (OD) is represented by logarithm with base 10 of opacity, and OD=log (1/T). Herein, T is transmittance, and a reciprocal number 1/T of the transmittance is opacity.

TABLE 3

Film thickness (μm)

| | 10 | 12 | 15 | 18 |
|---|---|---|---|---|
| No. 1 | 4.6 | 5.1 | — | — |
| No. 2 | 4.5 | 5 | 6< | — |
| No. 3 | 4.4 | 4.8 | 6< | 6< |
| No. 4 | 4.3 | 4.7 | 6< | 6< |
| No. 5 | 3.8 | 4 | 5.5 | 6< |
| No. 6 | 3.3 | 3.9 | 4.5 | 5.6 |

From the results shown in Table 2, it is found that the film shows better curing state according to the increase of the cyan pigment in the ink. This means that the irradiation intensity can be decreased or the irradiation time can be shortened, in a case of curing the ink having a same thickness.

In addition, from the results shown in Table 3, it is found that the OD tends to decrease with the increase of the cyan pigment. The light blocking property necessary for the microlens array is different depending on the shape or feature of each lens to be used. However, if OD=5.0 or more is set as a standard, the satisfying light blocking property is achieved when a film has a thickness of 12 μm or more. However, since the ink curing is insufficient with respect to ink Nos. 1 and 2, it is difficult to form a film from these inks in practical manufacturing conditions. With respect the ink Nos. 3 to 6, since the curing property is improved with the increase of the cyan pigment, both the preferable curing property and the preferable light blocking property can be achieved when a film has a thickness of 15 μm or more.

That is, in a case where as the light blocking material, a 100% black material or a material which blocks light is used, for obtaining a certain light blocking effect, more irradiation energy and irradiation time are necessary. In such a case, if more photopolymerization initiator is included in the ink, preservation stability of the ink may be decreased, or the curing property such as hardness may be decreased. Alternatively, it is necessary to perform plural times of applications, in each application a thin film of the ink is applied.

To the contrary, in the ink according to the embodiment, it is considered that, since the light absorbing ability of the cyan pigment is low within the wavelength region at which the photopolymerization initiator is sensitive, the sensitivity of the photopolymerization initiator is not affected by the cyan pigment. Accordingly, it is expected that the curing property can be improved by replacing a part of the light blocking material with the cyan pigment.

Also, in the ink prepared using the titanium black pigment instead of the carbon black pigment as the light blocking material, it was observed that, the same light blocking effect as the ink including the carbon black pigment was obtained, and the improvement of the curing property was expected with the combined use with the blue coloring material.

In the embodiment, the MFP is described as an image processing apparatus, however, it is not particularly limited thereto. A case of applying an image forming apparatus to an image reading device having only a scanner function, or a case of applying an image forming apparatus to an optical scanning unit of an electrophotographic printer is included in a range of the image processing apparatus according to the embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light blocking ink comprising:
a light blocking material;
a blue coloring material; and
a ultraviolet-curable material.

2. The ink according to claim 1, wherein
the blue coloring material is a phthalocyanine pigment.

3. The ink according to claim 2, wherein
a ratio of the blue coloring material with respect to the ink is greater than 2 weight % and smaller than 6 weight %.

4. The ink according to claim 3, wherein
the light blocking material contains at least one of carbon black and titanium black.

5. The ink according to claim 4, wherein
a ratio of the light blocking material with respect to the ink is greater than 5 weight % and smaller than 15 weight %.

6. The ink according to claim 3, wherein
a ratio of the light blocking material with respect to the ink is greater than 5 weight % and smaller than 15 weight %.

7. The ink according to claim 2, wherein
the light blocking material contains at least one of carbon black and titanium black.

8. The ink according to claim 7, wherein
a ratio of the light blocking material with respect to the ink is greater than 5 weight % and smaller than 15 weight %.

9. The ink according to claim 2, wherein
a ratio of the light blocking material with respect to the ink is greater than 5 weight % and smaller than 15 weight %.

10. The ink according to claim 1, wherein
a ratio of the blue coloring material with respect to the ink is greater than 2 weight % and smaller than 6 weight %.

11. The ink according to claim 10, wherein
the light blocking material contains at least one of carbon black and titanium black.

12. The ink according to claim 11, wherein
a ratio of the light blocking material with respect to the ink is greater than 5 weight % and smaller than 15 weight %.

13. The ink according to claim 10, wherein
a ratio of the light blocking material with respect to the ink is greater than 5 weight % and smaller than 15 weight %.

14. The ink according to claim 1, wherein
the light blocking material contains at least one of carbon black and titanium black.

15. The ink according to claim 14, wherein
a ratio of the light blocking material with respect to the ink is greater than 5 weight % and smaller than 15 weight %.

16. The ink according to claim 1, wherein
a ratio of the light blocking material with respect to the ink is greater than 5 weight % and smaller than 15 weight %.

17. A microlens array unit comprising:
a substrate;
a microlens array including a plurality of microlenses arranged on the substrate;
a light blocking film formed on the substrate and between adjacent microlenses, and including a light blocking material, a blue coloring material, and a ultraviolet-curable material.

18. The microlens array unit according to claim 17, wherein
a thickness of the light blocking film is greater than 15 μm and smaller than 18 μm.

19. An image processing apparatus comprising:
a light emitting element; and
a light receiving element including,
a microlens array unit through which light reflected from the image passes, the microlens array unit including,
a substrate,
a microlens array including a plurality of microlenses arranged on the substrate, and
a light blocking film formed on the substrate and between adjacent microlenses, and including a light blocking material, a blue coloring material, and a ultraviolet-curable material, and
an image sensor configured to receive the light passing through the microlens array unit and convert the received light into an electric signal.

20. The image processing apparatus according to claim 19, wherein
a thickness of the light blocking film is greater than 15 μm and smaller than 18 μm.
